(19) United States
(12) Patent Application Publication
(10) Pub. No.: US 2012/0097464 A1
(43) Pub. Date: Apr. 26, 2012

(54) CONTROL OF A SHUTTER VIA BI-DIRECTIONAL COMMUNICATION USING A SINGLE WIRE

(75) Inventor: Brennen R. Waugh, Beverly Hills, MI (US)

(73) Assignee: GM GLOBAL TECHNOLOGY OPERATIONS, INC., Detroit, MI (US)

(21) Appl. No.: 12/910,164

(22) Filed: Oct. 22, 2010

(51) Int. Cl. B60K 11/00; B60K 11/04; B60K 11/08

(52) U.S. Cl. 180/68.1

(57) ABSTRACT

A shutter system for controlling an airflow through a grille opening in a vehicle includes at least one louver. The shutter system also includes a mechanism configured to select a position for the at least one louver between and inclusive of fully-opened and fully-closed to control the airflow through the grille opening. The shutter system additionally includes a slave processor in operative communication with the mechanism and a master controller in bi-directional communication with the slave processor via a single wire. The master controller is adapted to control a selection of the position of the at least one louver by commanding the mechanism via the slave processor using solely the single wire. The slave processor is adapted to respond to the master controller using solely the single wire. A method of controlling operation of an adjustable shutter is also provided.

### TECHNICAL FIELD

The invention relates to control of a shutter via bi-directional communication using a single wire.

### BACKGROUND

A shutter is typically a solid and stable covering for an opening. A shutter frequently consists of a frame and louvers or slats mounted within the frame.

Louvers may be fixed, i.e., having a permanently set angle with respect to the frame. Louvers may also be operable, i.e., having an angle that is adjustable with respect to the frame for permitting a desired amount of light, air, and/or liquid to pass from one side of the shutter to the other. Depending on the application and the construction of the frame, shutters can be mounted to fit within, or to overlap the opening. In addition to various functional purposes, particularly in architecture, shutters may also be employed for largely ornamental reasons.

In motor vehicles, a shutter may be employed to control and direct a stream of light and/or air to various vehicle compartments. Therefore, a shutter may be employed to enhance comfort of vehicle passengers, as well as for cooling a range of vehicle systems. The control of such a shutter in a vehicle may be affected either mechanically or electro-mechanically.

### SUMMARY

A shutter system for controlling an airflow through a grille opening in a vehicle includes at least one louver. The shutter system also includes a mechanism configured to select a position for the at least one louver between and inclusive of fully-opened and fully-closed to control the airflow through the grille opening. The shutter system additionally includes a slave processor in operative communication with the mechanism and a master controller in bi-directional communication with the slave processor via a single wire, i.e., a single wire connection. The master controller is adapted to control a selection of the position of the at least one louver by commanding the mechanism via the slave processor using solely the single wire. The slave processor is adapted to respond to the master controller using solely the single wire.

The master controller may be further adapted to command the mechanism to one of select the fully-opened position, select the fully-closed position, and maintain a current position, i.e., the status quo, of the at least one louver. Accordingly, the mechanism may be additionally configured to respectively respond to the master controller that the at least one louver has one of opened, closed, and maintained the current position.

The master controller may be further adapted to generate a request for a diagnostic update from the mechanism on the position of the at least one louver. Accordingly, the mechanism may be additionally configured to provide a response to the request to provide the diagnostic update, wherein the response is indicative of one of a passing, a failing, and an indeterminate position of the at least one louver.

The vehicle may include an internal combustion engine and the airflow is used to cool the engine. The vehicle may additionally include a fan configured to be selectively turned on and off and adapted for drawing the airflow through the grille opening. In such a case, the master controller may be further adapted to selectively turn the fan on and off and to command the mechanism according to a load on the engine.

The engine may be cooled by a fluid circulated through a heat exchanger. The vehicle may additionally include a sensor adapted to sense a temperature of the fluid and configured to communicate the temperature to the master controller. Accordingly, the master controller may be further adapted to command the mechanism according to the sensed temperature of the fluid.

The master controller may be further adapted to monitor the ambient temperature and select and lock a predetermined position for the at least one louver in response to the ambient temperature being below a predetermined value.

The at least one louver may be arranged one of integral to the grille opening and adjacent to the grille opening.

A vehicle using the shutter system is also provided.

Additionally, a method of controlling operation of the shutter system via bi-directional communication is disclosed. The method includes commanding the mechanism using the single wire to select the fully-opened position of the at least one louver and responding to the command to select the fully-opened position of the at least one louver by the mechanism using the single wire. The method also includes commanding the mechanism to select the fully-closed position of the at least one louver and responding to the command to select the fully-closed position of the at least one louver by the mechanism using the single wire. The method additionally includes commanding the mechanism to maintain a current position of the at least one louver and responding to the command to maintain the current position of the at least one louver by the mechanism using the single wire.

The method may also include requesting a diagnostic update regarding the position for the at least one louver using the single wire. The method may additionally include responding to the request to provide the diagnostic update using the single wire, wherein the diagnostic update includes one of a passing, a failing, and an indeterminate response.

According to the method, each of said commanding the at least one louver to open, close, and maintain the current position, and said requesting the diagnostic update may be accomplished by a master controller. Furthermore, according to the method, each of said responding to the command to open, close, and maintain the current position, and said responding to the request to provide the diagnostic update may be accomplished by a slave processor operatively connected to the mechanism.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a partial side cross-sectional view of a vehicle having a shutter system depicted in a fully-closed state;

FIG. 2 is a partial side cross-sectional view of a vehicle having the shutter system shown in FIG. 1, with the shutter system depicted in an intermediate state;

FIG. 3 is a partial side cross-sectional view of a vehicle having the shutter system shown in FIGS. 1 and 2, with the shutter system depicted in a fully-opened state;

FIG. 4 is a schematic diagram of an exemplary electrical circuit employed to control operation of the shutter system depicted in FIG. 1-3; and

FIG. 5 is a flow chart illustrating a method controlling operation of the shutter system depicted in FIGS. 1-3.

### DETAILED DESCRIPTION

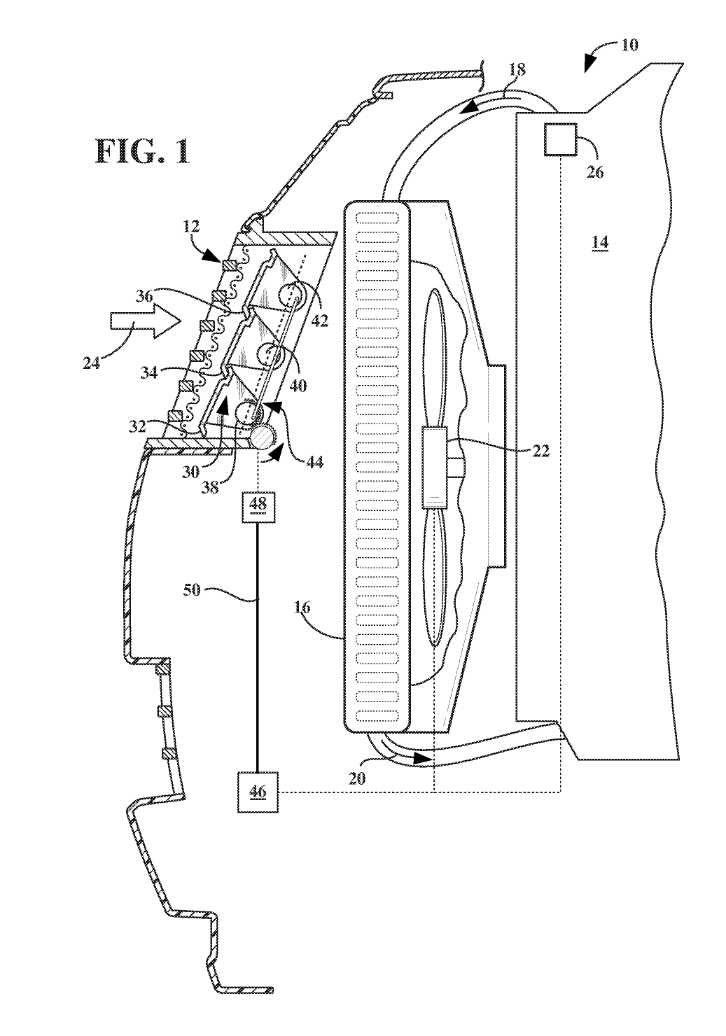

Referring to the drawings, wherein like reference numbers refer to like components, FIGS. 1-3 show a partial side view of a vehicle 10. The vehicle 10 is shown to include a grille opening 12 typically covered with a mesh. The grille opening 12 is adapted for receiving ambient air. The vehicle 10 additionally includes a powertrain that is specifically represented by an internal combustion engine 14. The powertrain of the vehicle 10 may additionally include a transmission, and, if the vehicle is a hybrid type, one or more motor-generators, none of which is shown, but the existence of which can be appreciated by those skilled in the art. Efficiency of a vehicle powertrain is generally influenced by its design, as well as by the various loads the powertrain sees during its operation.

The vehicle 10 additionally includes an air-to-fluid heat exchanger 16, i.e., a radiator, for circulating a cooling fluid shown by arrows 18 and 20, such as water or a specially formulated coolant, though the engine 14 to remove heat from the engine. A high-temperature coolant entering the heat exchanger 16 is represented by the arrow 18, and a reduced-temperature coolant being returned to the engine is represented by the arrow 20. The heat exchanger 16 is positioned behind the grille opening 12 for protection of the heat exchanger from various road-, and air-borne debris. The heat exchanger 16 may also be positioned in any other location, such as behind a passenger compartment, if, for example, the vehicle has a rear or a mid-engine configuration, as understood by those skilled in the art.

As shown in FIGS. 1-3, a fan 22 is positioned in the vehicle 10, behind the heat exchanger 16, such that the heat exchanger 16 is positioned between the grille opening 12 and the fan. The fan 22 is capable of being selectively turned on and off based on the cooling needs of the engine 14. Depending on the road speed of the vehicle 10, the fan 22 is adapted to either generate or enhance a stream of air or airflow 24 through the grille opening 12, and toward and through the heat exchanger 16. Thus generated or enhanced through the action of the fan 22, the airflow 24 is passed through the heat exchanger 16 to remove heat from the high-temperature coolant 18 before the reduced-temperature coolant 20 is returned to the engine 14. The fan 22 may be driven either electrically, or mechanically, directly by engine 14. The vehicle 10 additionally includes a coolant sensor 26 configured to sense a temperature of the high-temperature coolant 18 as it exits the engine 14.

Because the fan 22 is driven by the engine 14, size of the fan is typically selected based on the smallest fan that in combination with the available grille opening 12 is sufficient to cool the engine during severe or high load conditions imposed on the vehicle 10. Typically, however, when the size of the grille opening 12 is tailored to such severe load conditions, the grille opening generates significant aerodynamic drag on the vehicle which causes a loss in operating efficiency of the engine 14. On the other hand, if the size of the grille opening 12 is chosen based on the aerodynamic and operating efficiency requirements at higher vehicle speeds, the size of the fan 22 that is required to generate sufficient airflow at high load conditions becomes so great, that the fan generates significant parasitic drag on the engine 14. Therefore, an adjustable or variable size for the grille opening 12 would permit the fan 22 to be sized for minimum parasitic drag on the engine 14, while being capable of satisfying the high vehicle load cooling requirements. At the same time, such an adjustable grille opening 12 would permit selection of a smaller fan that would further serve to increase the operating efficiency of the powertrain.

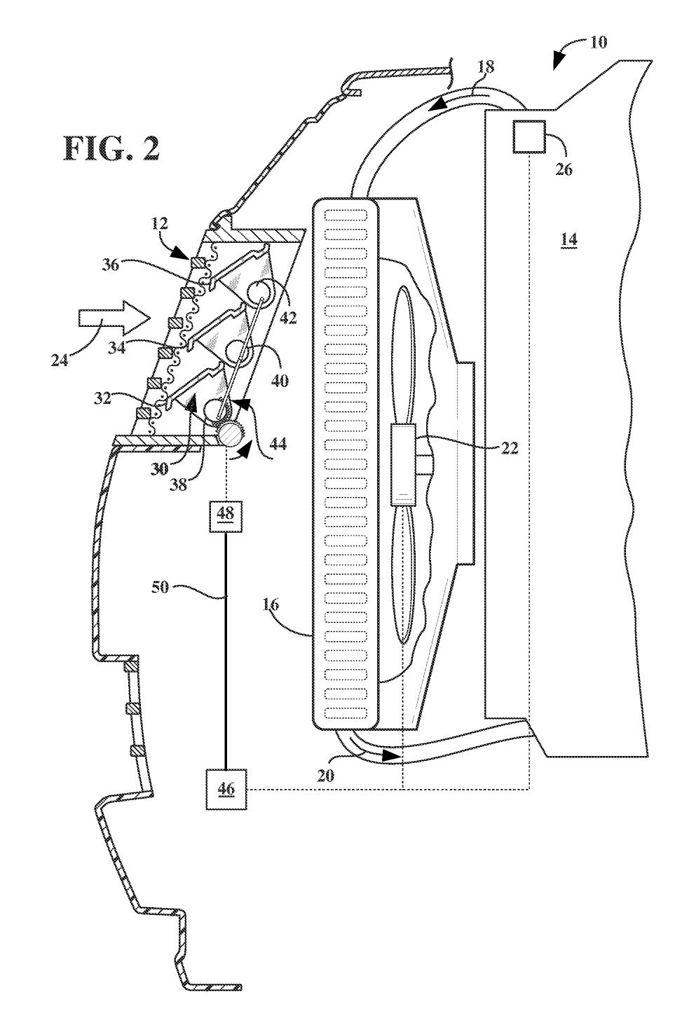

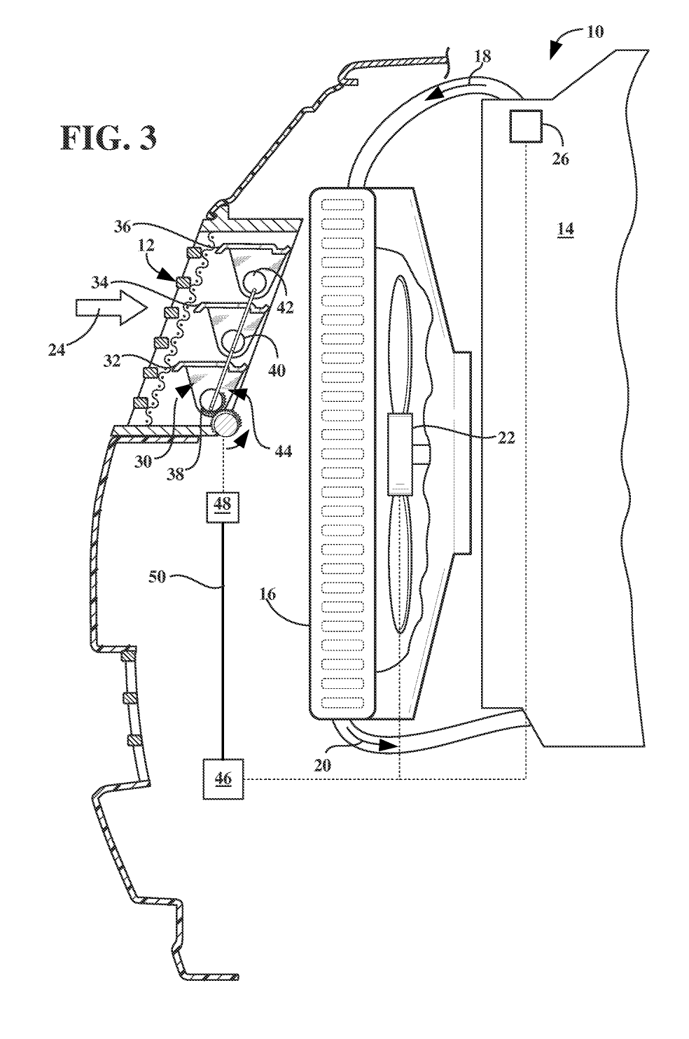

FIGS. 1-3 also depict a shutter system 30. The shutter system 30 is secured in the vehicle 10 and is adapted to control the airflow 24 through the grille opening 12. As shown, the shutter system 30 is positioned behind, and immediately adjacent to the grille opening 12 at the front of the vehicle 10. As shown, the shutter system 30 is positioned between the grille opening 12 and the heat exchanger 16. The shutter system 30 may also be incorporated into and be integral with the grille opening 12. The shutter system 30 includes at least one louver, herein shown as having three individual louver elements or louvers 32, 34, and 36, but the number of louvers may either be fewer or greater. Each louver 32, 34, and 36 is configured to rotate about a respective pivot axis 38, 40, and 42 during operation of the shutter system 30, thereby effectively controlling the size of the grille opening 12. The shutter system 30 is adapted to operate between and inclusive of a fully-closed position or state of the louvers 32-36 (as shown in FIG. 1), through an intermediate position (as shown in FIG. 2), and to a fully-opened position (as shown in FIG. 3). When the louvers 32, 34, and 36 are in any of their open positions, the airflow 24 penetrates the plane of the louvers 32-36 before coming into contact with the heat exchanger 16.

The shutter system 30 also includes a mechanism 44 configured to select a desired position for the louvers 32-36 between and inclusive of fully-opened and fully-closed. The mechanism 44 is configured to cause the louvers 32-36 to rotate in tandem, i.e., substantially in unison, and to permit the louvers to rotate into any of the available positions. The mechanism 44 may be adapted to select and lock either discrete intermediate position(s) of the louvers 32-36, or to infinitely vary position of the louvers between and inclusive of the fully-opened and fully-closed. The mechanism 44 acts to select the desired position for the louvers 32-36 when activated by any appropriate device, as understood by those skilled in the art, such as an electric motor (not shown). The vehicle 10 also includes a master controller 46, which may be an engine controller or a separate control unit, configured to regulate the mechanism 44 for selecting the desired position of the louvers 32-36. The master controller 46 may also be configured to operate the fan 22, if the fan is electrically driven, and a thermostat (not shown) that is configured to regulate the circulation of coolant, as understood by those skilled in the art.

The master controller 46 is programmed to regulate the mechanism 44 according to the load on the engine 14 and, correspondingly, to the temperature of the coolant sensed by the sensor 26. The temperature of the high-temperature coolant 18 is increased due to the heat produced by the engine 14 under load. As known by those skilled in the art, a load on the engine is typically dependent on operating conditions imposed on the vehicle 10, such as going up a hill and/or pulling a trailer. The load on the engine 14 generally drives up internal temperature of the engine, which in turn necessitates cooling of the engine for desired performance and reliability. Prior to exiting the engine 14, coolant is routed inside the engine in order to most effectively remove heat from critical engine components, such as bearings (not shown, but known by those skilled in the art). Typically, the coolant is continuously circulated by a fluid pump (not shown) between the engine 14 and the heat exchanger 16.

When the louvers 32-36 are fully-closed, as depicted in FIG. 1, the louvers provide blockage of the airflow 24 at the grille opening 12. A shutter system 30 with fully-closed louvers 32-36 provides optimized aerodynamics for the vehicle 10 when engine cooling through the grille opening 12 is not required. The shutter system 30 may also be regulated by the master controller 46 to variably restrict access of the oncoming airflow 24 to the heat exchanger 16, by rotating the louvers 32-36 to an intermediate position, as shown in FIG. 2, where the louvers are partially closed. An appropriate intermediate position of the louvers 32-36 is selected by the master controller 46 according to a programmed algorithm to thereby affect the desired cooling of the engine 14. When the louvers 32-36 are fully-opened, as shown in FIG. 3, each louver is rotated to a position parallel to the airflow 24 seeking to penetrate the shutter system plane. Thus, fully-opened louvers 32-36 are configured to permit a generally unfettered passage of such a stream of air through the louver plane of the shutter system 30.

The shutter system 30 influences cooling of the engine 14, and thus also affects exhaust emissions generated by the engine. Consequently, the operation of the shutter system 30 may need to be monitored for compliance with various government rules and regulations, such as On-Board Diagnostics standards (OBD). As known by those skilled in the art, OBD standards require a vehicle to include self-diagnostic and reporting capability for certain key systems. To such an end, the master controller 46 is programmed to monitor the operation of the shutter system 30 in order to verify that a command from the master controller has resulted in the desired response from the louvers 32-36.

Accordingly, when the position of the louvers 32-36 is changed by the master controller 46 generating a command to the mechanism 44, the mechanism is adapted to generate a response to the master controller with respect to whether the louvers have adopted the commanded position. In order to generate such a response, the mechanism 44 is arranged in operative communication with a slave processor 48. The slave processor 48 may either be incorporated into the mechanism 44 or be a stand-alone device. The slave processor 48 is adapted to change the position of the louvers 32-36 via the mechanism 44 solely based on the received commands from the master controller 46. Additionally, the master controller 46 is adapted to receive the communication from the slave processor 48 regarding the status of the response of the louvers 32-36.

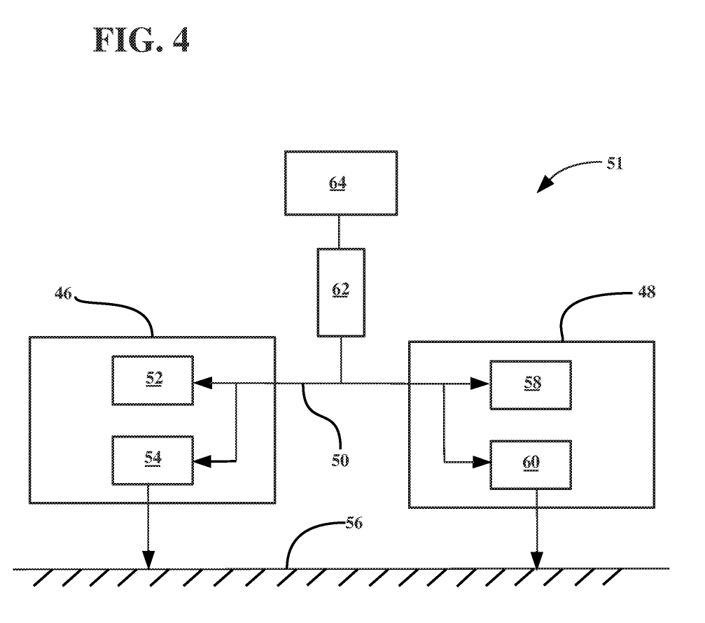

As depicted by an exemplary electrical circuit 51 shown in FIG. 4, the master controller 46 is in operative communication with the slave processor 48 via a single wire 50, i.e., a single wire connection, such that the master controller and the slave processor are adapted for bi-directional communication. Accordingly, the command for the selection of position of the louvers 32-26 is accomplished by the master controller 46 communicating with the slave processor 48 via the bi-directional communication using solely the single wire 50. Likewise, the slave processor 48 is adapted to respond to the master controller 46 regarding the status of the response of the louvers 32-36 to the command via the bi-directional communication using solely the same single wire 50. The term “bi-directional communication” is used herein to denote electrical communication traveling both from the master controller 46 to the slave processor 48 and in reverse using the same single wire 50.

The master controller 46 is further adapted to communicate a command to the slave processor 48 for the mechanism 44 to either select the fully-opened, the fully-closed position, or any predetermined intermediate position between the fully-opened and the fully-closed positions. When appropriate, the master controller 46 is additionally adapted to communicate a command to the slave processor 48 for the mechanism 44 to maintain a current position, i.e., the status quo, of the louvers 32-26. The slave processor 48 is further adapted to respectively respond to the master controller 46 that the louvers 32-26 have either opened or closed, or have maintained the current position.

The master controller 46 may also be adapted to communicate a request to the slave processor 48 for a diagnostic update from the mechanism 44 on the position of the louvers 32-26. Additionally, the slave processor 48 may be adapted to provide a response to the request from the master controller 46 to provide the diagnostic update. In such a case, the response from the slave processor 48 is indicative of one of a passing, a failing, and an indeterminate position of the louvers 32-26.

FIG. 4 additionally depicts the master controller 46 including a pulse width modulator (PWM) 52, which is a timer input channel of the master controller that may alternately receive and transmit a pulse width modulated signal. As shown, the master controller 46 also includes a PWM output device 54, which is a switch that is adapted to generate a square wave signal and provide a low impedance pass to a ground 56. As shown, the slave processor 48 also includes a pulse width modulator (PWM) 58, which is a timer input channel of the slave processor that may alternately receive from and transmit to the PWM 52 a pulse width modulated signal. As shown, the slave processor 48 includes a PWM output device 60, which is a switch similar to the PWM output device 54, and which is similarly adapted to generate a square wave signal and provide a low impedance pass to the ground 56. The slave processor 48 additionally includes a resistor 62, which is connected to an energy storage device 64, such as a battery.

As shown in FIG. 4, PWM input devices 52 and 58 are directly connected via the single wire 50 for bi-directional communication. The communication channel, as provided by the single wire 50, is constantly open and the flow of information between the master controller 46 and the slave processor 48 is continuous. Furthermore, according to the construction of the depicted circuit 51, the master controller 46 functions as a “master” module, while the slave processor 48 functions as a “slave” module. In other words, the operation of the mechanism 44 is entirely dependent on the master controller 46, and the mechanism may not take any action without a proper command from the master controller. The single wire 50 and the bi-directional communication enable such a master-slave relationship between the master controller 46 and the slave processor 48 which may be mandated by various government regulations.

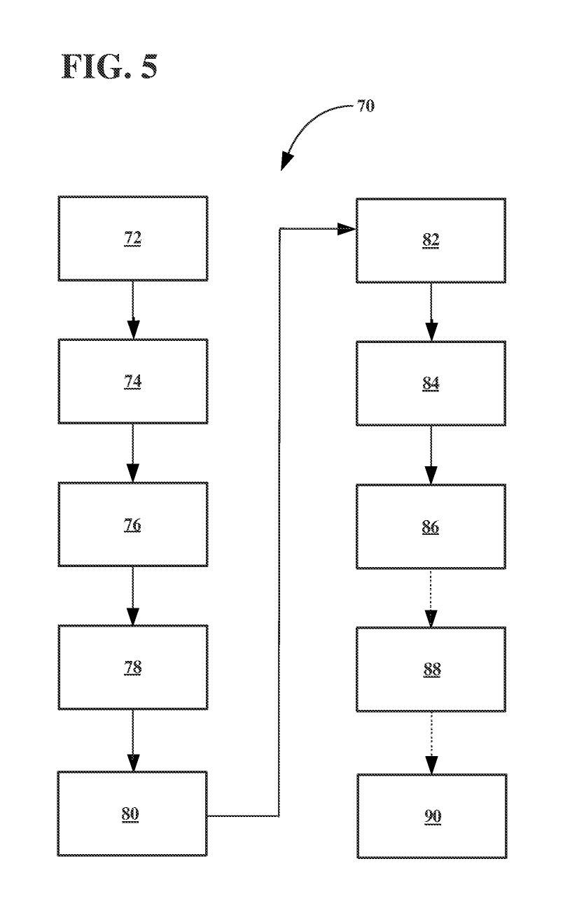

FIG. 5 depicts a method 70 for controlling operation of the shutter system 30 via bi-directional communication, as described above with respect to FIGS. 1-4. The method commences in frame 72 and then proceeds to frame 74 where it includes monitoring the operation and current position of the louvers 32-36 via the master controller 46. Following frame 74, the method advances to frame 76. In frame 76, the method includes commanding the mechanism 44 to select the fully-opened position of the louvers 32-36 with the slave processor 48 using the single wire 50. Following frame 76, the method proceeds to frame 78, where it includes responding to the command to select the fully-opened position of the louvers 32-36 by the mechanism 44 via the slave processor 48 using the single wire 50.

After frame 78, the method progresses to frame 80, where the method includes commanding the mechanism 44 using the single wire 50 to select the fully-closed position of the louvers 32-36. From frame 80, the method advances to frame 82, where the method includes responding to the command to select the fully-closed position of the louvers 32-36 by the slave processor 48 using the single wire 50. After frame 82, in frame 84 the method includes commanding the mechanism 44 to maintain a current position of the louvers 32-36 using the single wire 50. From frame 84, the method advances to frame 86. In frame 86, the method includes responding to the command to maintain the current position of the louvers 32-36 by the slave processor 48 using the single wire 50.

Additionally, after frame 86, the method may proceed to frame 88. In frame 88, the method may include requesting by the master controller 46 a diagnostic update regarding the position of the louvers 32-36 using the single wire 50. Following frame 88, the method may advance to frame 90 where it includes responding to the request to provide the diagnostic update with the slave processor 48 using the single wire 50, as described above with respect to FIG. 4.

While the best modes for carrying out the invention have been described in detail, those familiar with the art to which this invention relates will recognize various alternative designs and embodiments for practicing the invention within the scope of the appended claims.

1. A shutter system for controlling an airflow through a grille opening in a vehicle, the shutter system comprising:
at least one louver;
a mechanism configured to select a position for the at least one louver between and inclusive of fully-opened and fully-closed to control the airflow through the grille opening;
a slave processor in operative communication with the mechanism; and
a master controller in bi-directional communication with the slave processor via a single wire;
wherein the master controller is adapted to control a selection of the position of the at least one louver by commanding the mechanism via the slave processor using solely the single wire; and
wherein the slave processor is adapted to respond to the master controller using solely the single wire.

2. The shutter system of claim 1, wherein the master controller is further adapted to communicate a command to the slave processor for the mechanism to one of select the fully-opened position, select the fully-closed position, and maintain a current position of the at least one louver, and the slave processor is further adapted to respectively respond to the master controller that the at least one louver has one of opened, closed, and maintained the current position.

3. The shutter system of claim 1, wherein the master controller is further adapted to communicate a request to the slave processor for a diagnostic update from the mechanism on the position of the at least one louver, and the slave processor is further adapted to provide a response to the request to provide the diagnostic update, wherein the response is indicative of one of a passing, a failing, and an indeterminate position of the at least one louver.

4. The shutter system of claim 1, wherein the vehicle includes an internal combustion engine and the airflow is used to cool the engine.

5. The shutter system of claim 4, wherein the vehicle includes a fan configured to be selectively turned on and off and adapted for drawing the airflow through the grille opening, and the master controller is further adapted to selectively turn the fan on and off and to command the mechanism according to a load on the engine.

6. The shutter system of claim 4, wherein the engine is cooled by a fluid circulated through a heat exchanger, the vehicle includes a sensor adapted to sense a temperature of the fluid and configured to communicate the temperature to the master controller, and the master controller is further adapted to command the mechanism according to the sensed temperature of the fluid.

7. The shutter system of claim 1, wherein the master controller is further adapted to monitor the ambient temperature and select and lock a predetermined position of the at least one louver in response to the ambient temperature being below a predetermined value.

8. The shutter system of claim 1, wherein the at least one louver is arranged one of integral to the grille opening and adjacent to the grille opening.

9. A vehicle comprising:
an internal combustion engine cooled by a fluid;
a fan capable of being selectively turned on and off and adapted for cooling the engine:
a grille opening located on the vehicle relative to the fan and adapted for receiving an airflow;
a heat exchanger positioned between the grill opening and the fan for circulating the fluid though the engine; and
a shutter system arranged relative to the grille opening and proximate the fan for controlling the airflow through the grille opening, wherein the shutter system includes at least one louver, a mechanism configured to select a position for the at least one louver between and inclusive of the fully-opened and the fully-closed positions to selectively restrict and unrestrict the grille opening, a slave processor in operative communication with the mechanism, and a master controller in bi-directional communication with the slave processor via a single wire;
wherein the master controller is adapted to control a selection of the position of the at least one louver by commanding the mechanism using the slave processor using the single wire; and
wherein the slave processor is adapted to respond to the master controller using the single wire.

10. The vehicle of claim 9, wherein the master controller is further adapted to communicate a command to the slave processor for the mechanism to one of select the fully-opened position, select the fully-closed position, and maintain a current position of the at least one louver, and the slave processor is further adapted to respectively respond to the master controller that the at least one louver has one of opened, closed, and maintained the current position.

11. The vehicle of claim 9, wherein the master controller is further adapted to communicate a request to the slave processor for a diagnostic update from the mechanism on the position of the at least one louver, and the slave processor is further adapted to provide a response to the request to provide the diagnostic update, wherein the response is indicative of one of a passing, a failing, and an indeterminate position of the at least one louver.

12. The vehicle of claim 9, wherein the master controller is further adapted to selectively turn the fan on and off and to command the mechanism according to a load on the engine.

13. The vehicle of claim 9, wherein the shutter system additionally includes a sensor adapted to sense a temperature of the fluid and configured to communicate the temperature to the master controller, and the master controller is further adapted to command the mechanism according to the sensed temperature of the fluid.

14. The vehicle of claim 9, wherein the master controller is further adapted to monitor the ambient temperature and select and lock a predetermined position of the at least one louver in response to the ambient temperature being below a predetermined value.

15. The vehicle of claim 9, wherein the at least one louver is arranged one of integral to the grille opening and adjacent to the grille opening.

16. A method of controlling operation of a shutter system via bi-directional communication, the shutter system having at least one louver and a mechanism configured to select a position of the at least one louver between and inclusive of fully-opened and fully-closed to control an airflow through a grille opening in a vehicle, the method comprising:
commanding the mechanism to select the fully-opened position of the at least one louver using a single wire;
responding to the command to select the fully-opened position of the at least one louver by the mechanism using the single wire;
commanding the mechanism to select the fully-closed position of the at least one louver using the single wire;
responding to the command to select the fully-closed position of the at least one louver by the mechanism using the single wire;
commanding the mechanism to maintain a current position of the at least one louver using a single wire; and
responding to the command to maintain the current position of the at least one louver by the mechanism using the single wire.

17. The method of claim 16, further comprising requesting a diagnostic update regarding the position for the at least one louver using the single wire.

18. The method of claim 17, wherein each of said commanding the at least one louver to open, close, and maintain the current position, and said requesting the diagnostic update is accomplished by a master controller.

19. The method of claim 17, further comprising responding to the request to provide the diagnostic update using the single wire, wherein the diagnostic update includes one of a passing, a failing, and an indeterminate response.

20. The method of claim 18, wherein each of said responding to the command to open, close, and maintain the current position, and said responding to the request to provide the diagnostic update is accomplished by a slave processor operatively connected to the mechanism.
